(19) United States
(12) Patent Application Publication
(10) Pub. No.: US 2014/0019290 A1
(43) Pub. Date: Jan. 16, 2014

(54) IMAGE DATA COLLECTION

(71) Applicant: Zazzle.com, Inc., Redwood City, CA (US)

(72) Inventor: Jeffrey J. Beaver, San Francisco, CA (US)

(21) Appl. No.: 13/939,147

(22) Filed: Jul. 10, 2013

Related U.S. Application Data
(60) Provisional application No. 61/669,734, filed on Jul. 10, 2012.

(51) Int. Cl. G06Q 30/06

(52) U.S. Cl. CPC G06Q 30/0621
USPC 705/26.5; 705/26.81

(57) ABSTRACT

Techniques for collecting media, such as pictures, video, and audio about customized products that have been delivered to customers are provided. In response to determining that a customer has received a unit of a product that the customer ordered from a merchant, the merchant sends the customer a prompt to take a picture of (or otherwise record information about) the unit. The prompt may be a SMS text message that is sent to a mobile phone of the customer, which mobile phone may include a camera. The customer replies to the prompt by taking a digital image of the unit and attaching (or embedding) the picture in a reply message that is sent to the merchant. The merchant stores the digital image in association with the product. The merchant provides a web page that allows other users to view the digital image in association with the product.

### CROSS-REFERENCE TO RELATED APPLICATIONS; BENEFIT CLAIM

This application claims the benefit of U.S. Provisional Application No. 61/669,734, filed Jul. 10, 2012, the entire contents of which is hereby incorporated by reference as if fully set forth herein, under 35 U.S.C. §119(e).

### FIELD OF THE DISCLOSURE

The present disclosure generally relates to computer-based techniques for communicating digital image data between an image forming unit and an image storing unit. The disclosure relates more specifically to techniques for collecting digital images from a remote location using a process that has minimal complexity for the remotely located user.

### BACKGROUND

Sales of products using online facilities such as consumer-facing catalog-style websites have become ubiquitous. Standard operating practice for these sites includes displaying digital images of products so that prospective customers can evaluate the dimensions, appearance, and quality of goods before the goods are ordered and received. In this context, returning unsatisfactory goods is relatively inconvenient and involves shipping costs and time delays; therefore, consumers prefer to have clear, understandable digital images of products.

For merchants who sell mass-manufactured goods, creating and storing digital images depicting the products is straightforward. The manufacturer or its vendor simply takes a picture of a sample product using a digital camera or smartphone, uploads the image to a host computer, and copies the image into a product database or website catalog page. However, merchants who offer made-to-order, custom-manufactured goods cannot photograph samples in advance because sample products are simply not available. Further, the custom-manufactured goods typically are drop-shipped directly from a just-in-time manufacturing site to the customer and, therefore, the merchant does not have a reasonable opportunity anywhere in the sales cycle to photograph finished custom-manufactured goods. Consequently, prospective customers of custom-manufactured goods may be unable to see an image of actual custom-manufactured goods that previous customers have received of the same class or category.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY OF THE INVENTION

The appended claims may serve as a summary of the invention.

### BRIEF DESCRIPTION OF THE DRAWINGS

In the drawings:

FIG. 1 illustrates a networked computer system in which an embodiment may be used.

FIG. 2 illustrates a method of collecting digital images.

FIG. 3 illustrates a computer system with which an embodiment may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

General Overview

Techniques are described for collecting media from customers who receive products that have been shipped to their respective residences. Such media includes digital images, video, and audio. A customer orders a product from a merchant and eventually receives a unit (or custom version) of the product from a shipper that is associated with the merchant. The merchant determines that a particular unit of the product has been delivered. This determination may involve the shipper notifying the merchant when the unit has been delivered. The notification may be in response to the merchant sending, to the shipper, a request for the delivery status of the unit. In response to receiving the notification, the merchant sends, to the customer, a message (e.g., SMS message or email or a proprietary message) that prompts the customer take a picture of (or record information about) the unit. This message is referred to herein as a “picture prompt” even though the prompt may be to take video of, or record audio about, the particular unit. Alternatively, the prompt may be to perform a 3D scan of the unit. The customer sends the picture (or video or audio) to the merchant using a communication channel (e.g., text messaging or email), which may be different than the communication channel on which the picture prompt was sent.

Example Networked Computer Architecture

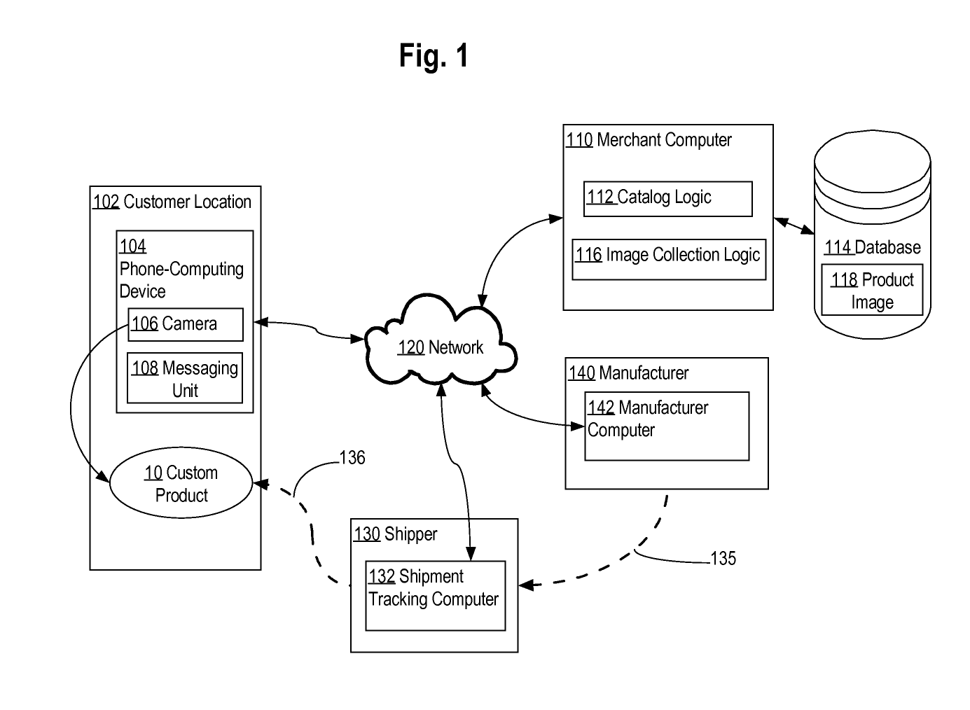

FIG. 1 illustrates a networked computer system 100 in which an embodiment may be used. Networked computer system 100 includes a merchant computer 110 that hosts catalog logic 112 and image collection logic 116 and is coupled to a database 114 that contains records relating to products available for purchase including one or more product images 118 for products. In an embodiment, merchant computer 110 is associated with a merchant that offers custom-manufactured products. An example of such a merchant is Zazzle Inc., of Redwood City, Calif., but other embodiments may be implemented for other merchants of different types. Merchant computer 110 may be implemented as any number of individual computers or as a data center having computers that are brought online and moved offline according to capacity needs.

In general, catalog logic 112 implements a product catalog or online site that customers can browse to review available product categories and products, and to specify parameters for custom manufacture of products. Examples of custom-manufactured products include clothing, accessories, cards & postage, home & pet products, office products, art & posters, food, furniture, electronics, photo gifts, other gifts, etc. The custom-manufactured products may be customized with any of customer-specified options such as fabrics, styles, colors, sizes, ingredients, accessories and/or embellishments such as images, graphics, logos, and other elements. For example, a customer could browse the catalog to view product category Clothing, product type Hoodies & Sweatshirts, and select Create Your Own Sweatshirt; the customer could then upload a digital image to be custom printed on one or more sweatshirts of a specified size and color. In an embodiment, browsing through categories and product types causes generating and displaying one or more pages that include graphical images of the expected appearance of products, or sample products that the merchant has caused to be made for demonstration purposes. However, the images do not show images of products that have been previously ordered by real customers. While this example illustrates that some products (e.g., clothes and coffee mugs) may have numerous possible embellishments, many other products have a seemingly unlimited array of product options that are not related to embellishments. For example, a leather purse may be customized in terms of type of leather, type and size of buckle, strap length, and inner lining of the purse.

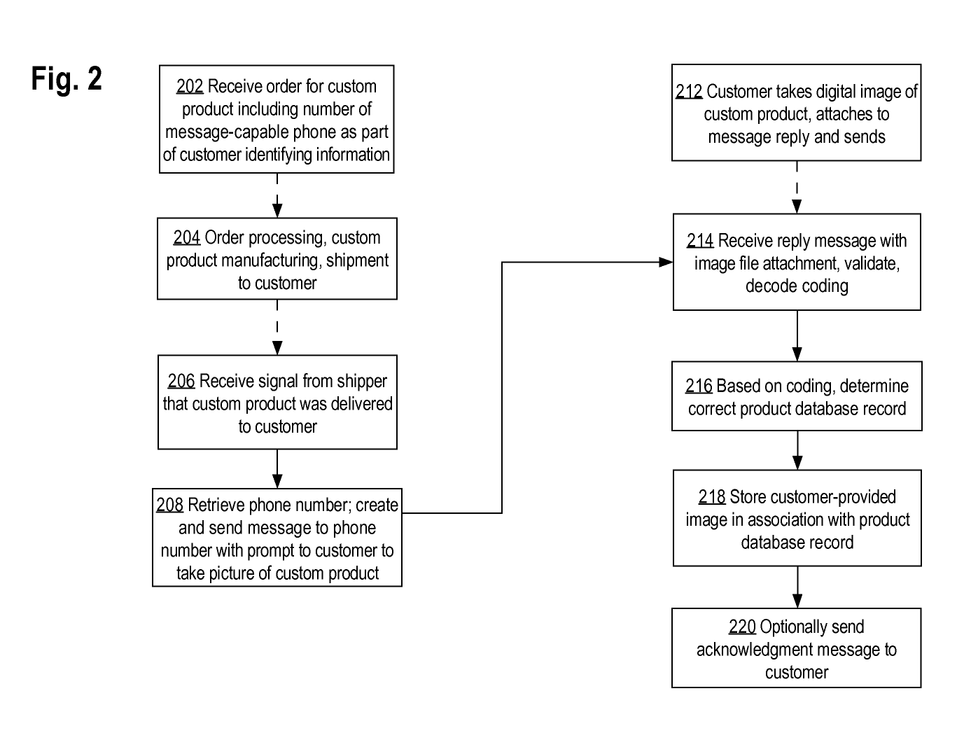

Image collection logic 116 comprises one or more computer programs or other software elements that are configured to perform aspects of the techniques described herein including the approach of FIG. 2.

Merchant computer 110 is coupled to network 120, which represents one or more local networks, wide area networks, internetworks and global networks such as the internet.

A manufacturer 140 includes a manufacturer computer 142 that is coupled to network 120 and is associated with a manufacturer of custom-manufactured products. In an embodiment, the manufacturer and the merchants are separate. In another embodiment, merchant computer 110 and manufacturer computer 142 are co-located and associated with the same entity. In either embodiment, manufacturer computer 142 is configured to receive order data representing orders for custom-manufactured products. Thus, merchant computer 110 receives orders from customer computers, and transfers order data to manufacturer computer 142 for use on a manufacturing floor or in automatic manufacturing equipment. Completed, manufactured products move to a shipper 130 as indicated by arrow 135.

Shipper 130 includes a shipment tracking computer 132 that is coupled to network 120 and is associated with a shipping or transportation service. Examples include a courier service, trucking service, package service, etc. Current specific examples of shipper 130 include UPS, FedEx, and USPS. In an embodiment, the manufacturer, merchant and shipper are separate but in other embodiments, various combinations of manufacturer, merchant, and shipper may be implemented. For example, shipper 130 may be the same entity as the manufacturer. Shipper 130 typically receives parcels, envelopes or other transportable items from manufacturer 140 along with indicating a customer address, shipping method, and related transportation details.

Shipment tracking computer 132 stores data about the customer order, customer address, transportation details and status of transit for each individual item that is shipped from the manufacturer 140 to a customer location 102. For example, shipment tracking computer 132 implements an online item tracking facility with which a customer, merchant or manufacturer can retrieve, using a networked computer, the then-current status of shipment of a particular item including item location. In an embodiment, shipment tracking computer 132 is logically coupled to merchant computer 110 so that the merchant can obtain status data for each item associated with any particular customer order that originated at the merchant. In other words, the merchant may integrate its tracking facility with the shipper's online item tracking facility. Thus, the merchant associates the shipper's unique shipment tracking number/code with the merchant's own internal order/item codes. Shipments of items move from shipper 130 to customer location 102 as indicated by arrow 136.

In an alternative embodiment, manufacturer 140 provides customers a “pickup” or “will call” option where the customers pick up their orders at a designated location instead of passively waiting for ordered items to be shipped directly to their respective residences. This approach is helpful for manufacturers who are local to a majority of their customers, such as some food providers. At pickup, manufacturer 140 may prompt (whether verbally or with visible signs) customers to take a picture of their respective ordered items. Additionally or alternatively, at the time of purchase or pickup of an ordered item by a customer, manufacturer computer 142 may store electronic data that indicates that the customer has purchased or picked up an ordered item. Manufacturer computer 142 may automatically send a notification to merchant computer 110 of the pickup/purchase or merchant computer 110 may request a current status of an order from manufacturer computer 142. Either way, in response to determining that a customer has picked up an item from manufacturer 140, merchant computer 110 sends a picture prompt to the customer.

In an alternative embodiment, manufacturer 140 is responsible for delivering an ordered item to a customer, instead of relying on shipper 130. An agent of manufacturer 140 (e.g., a delivery person) may send, to merchant computer 110, a notification that an ordered item is about to be delivered to a customer or that the ordered item has recently been delivered to the customer. The device that the agent uses may be a desktop computer or a handheld device that has a dedicated application that is configured to communicate delivery information to merchant computer 110 over network 120.

A customer location 102 is associated with an individual or institutional customer of the custom manufactured products. Customer location 102 may include a custom product 10 that the customer has ordered through merchant computer 110 and received from shipper 130 after manufacture by manufacturer 140.

Customer location 102 may include a phone-computing device 104 that includes at least a camera 106 and a messaging unit 108. Examples of phone-computing device include camera-equipped cellular radiotelephones such as IPHONE smartphones and ANDROID-based smartphones. In embodiments in which device 104 is a smartphone, messaging unit 108 may correspond to cellular radiotelephone communication circuitry and software configured to implement Short Message Service (SMS) text messaging, or the equivalent. Alternatively, messaging unit 108 may correspond to an application that is provided by the merchant or a third-party.

In a related embodiment, device 104 is a personal computer, laptop computer, netbook or ultrabook computer, wearable computing device, or tablet computer coupled to a digital camera and hosting or executing messaging software such as an e-mail communication program. In such an embodiment, messaging unit 108 may correspond to the e-mail communication software (or software application provided by the merchant) and network stack of the computer. If device 104 does not have a camera or audio recording capabilities, then a customer may use a separate device (e.g., camera or audio recorder) to take a picture or record video and/or audio regarding a product received through shipper 130. The customer may then upload the created media item (whether digital image, video, or audio) from the separate device to device 104, which sends the media item to merchant computer 110.

Example Method of Collecting Digital Images

FIG. 2 illustrates a method of collecting digital images. Broken lines indicate steps that may be performed at geographically dispersed locations or separated by arbitrary time periods. Solid lines indicate steps that typically proceed promptly one after another in a time sequence or in real time.

At block 202, an order for a custom product is received. The order may include a phone number of a message-capable phone as part of customer-identifying information. For example, as described previously, a customer may browse through a website or catalog of product information and select a custom-manufactured product to order. A checkout or shopping cart process may prompt the user to enter personally identifying information such as name, billing address, shipping address, home or business phone number, and payment information. The checkout or shopping cart process also may prompt the user to specify a cellular telephone number and/or an email address that can receive messages relating to the order. The cell phone number and/or email address may be stored in a data repository, such as database 114. Additionally or alternatively, the checkout process may prompt the user to download a mobile application provided by the merchant to allow the customer to communicate digital images from device 104 to merchant computer 110.

The customer may also specify a preferred method of communicating the digital images. For example, a customer may provide, to the merchant, a cell phone number and an email address, but may indicate that the customer prefers to be prompted through an application that is provided by the merchant and that is executing on the customer's handheld device. The picture prompt may be an iOS, Android, or other system notification.

In an embodiment, the checkout or shopping cart process allows the user to “opt-in” to receiving a picture prompt to take a picture (or video or audio) in response to the merchant determining that the product that is part of the order has been delivered. In this way, the user only receives the picture prompt if the user affirmatively agrees to it. Alternatively, a user is opted in automatically without requiring the user to affirmatively agree to receiving the “picture prompt.” In this embodiment, the checkout or shopping cart process may allow the user to opt out of receiving the picture prompt.

At block 204, order processing, custom product manufacturing, and shipment to the customer occur. In general, the customer order is received at merchant computer 110 and processed, manufacturer 140 is notified and commences custom manufacturing the custom product 10 based on the order details, and the manufacturer provides the custom product to the shipper 130 for shipment to customer location 102. During each such step, the computers shown in FIG. 1 may provide messages with data updates about the status of steps of the order, manufacture, and shipment process. In particular, merchant computer 110 is configured to associate a shipment code of shipment tracking computer 132 with the merchant's order number/code.

In an embodiment, shipment tracking computer 132 is configured to provide prompt or real-time updates to the merchant computer 110 as changes occur in the shipment process and as items move from the manufacturer 140 to the customer location 102. For example, when an order leaves the manufacturer 140 and is initially received at the shipper 130, the shipment tracking computer 132 sends an update to the merchant computer 110, providing the order identifier that indicates that the order status is “RECEIVED ON TRUCK” or the equivalent. Similarly, when a delivery person has completed delivering the custom product 10 (also referred to herein as a “unit”) to the customer location 102, the shipment tracking computer 132 receives an update (for example, from a driver in the field who sends an update using a handheld wireless network-linked computer) and sends the update to the merchant computer 110. This embodiment is referred to as a “push” approach where shipper 130 notifies the merchant when a delivery has occurred or when the shipment status has changed.

In an alternative embodiment, merchant computer 110 is configured to ping shipment tracking computer 132 for the current status of an order once the order's package(s) has left the manufacturing facility. For example, merchant computer 110 may send a request for a current shipment status report every five hours or thirty minutes until merchant computer 110 determines that a package has been delivered or is about to be delivered. This embodiment is referred to as a “pull” approach where the merchant is responsible for requesting delivery status information from shipper 130.

The particular hardware, software, and process steps used to accomplish the foregoing are not critical. Ultimately, the merchant receives a prompt signal from the shipper indicating that the custom product was delivered to the customer, as shown in block 206. The signal includes order identifying information, which the shipper had previously received either from the merchant or the manufacturer, sufficient to uniquely identify the order or the customer. Thus, the merchant computer 110 and shipment tracking computer 132 are relatively closely coupled so that the merchant acquires a definitive indication that a particular custom product was actually delivered to a particular customer.

In response to receiving the signal at block 206 for a particular order, at block 208, based on the information in the shipment signal, contact information for the customer is retrieved. For example, merchant computer 110 receives a signal from shipment tracking computer 132 and forms a query to database 114 based on order identifying information in the signal from the shipper 130. As a result, contact information for the customer is obtained. Examples of contact information include a cell phone number for use in contacting the customer, an email for the customer, and a mobile application that is installed on device 104.

As also shown in block 208, a message to the phone number (or email, or application executing on device 104) is created and sent, and the message prompts the customer to take a digital image of (or video or audio regarding) the custom product that was just received. For example, image collection logic 116 of the merchant computer 110 creates an SMS text message directed to the customer's cell phone number with the text: “Enjoying the items you just received from Zazzle? Share your items with the Zazzle community. Just take a picture of your items, reply to this and attach the picture. We'll add it to the product page so everyone can see what you got.” The foregoing text is merely an example and an embodiment may use any suitable message that prompts the user to make a digital image of an actually received custom product and reply with the digital image. Merchant computer 110 causes dispatching the message into the public telecommunications network using an SMS messaging component, which may be implemented as part of image collection logic 116 or separately implemented. While the present example describes using SMS text messaging to a cell phone, other embodiments may use e-mail messages directed to an email account of the customer, messages that are directed to a mobile application executing on device 104, or any Internet-enabled messaging system, such as Twitter or Facebook, with which the customer has an account.

In an embodiment, when a message is dispatched at block 208, merchant computer 110 stores data that indicates that a picture prompt has been sent to the customer, but that a reply message has not yet been received. Such data may comprise a row or record in a message table of database 114 that is keyed using the customer's cell phone number, and also includes a tag or action value indicating the last messaging action that occurred and which order the message pertains to. For example, one record might have the key value “213-555-1212” for the customer's cell phone number, the action value “1” to indicate that the last action taken by merchant computer 110 was sending the initial prompt message of block 208, and a unique order number such as “123456”. Thereafter, in response to receiving an inbound message from a customer, the merchant computer 110 extracts the sending party's contact information (e.g., email address or cell phone number from a standard SMS or SS7 telephony header) and looks up the corresponding row or record in the database 114. The action value is then evaluated to determine what action to take next.

In an embodiment, in response to receiving the signal from the shipper at block 206, the merchant does not immediately send a picture prompt to the customer. Instead, the picture prompt is delayed. Such a delay may be wise if the communication channel to be used to send the picture prompt is a SMS text message and it is determined that the current local time of the customer is during the night or early morning hours (e.g., between 10 PM and 8 AM).

In a related embodiment, the type of product that was ordered is a factor in determining when to send the picture prompt for that product. For example, for clothing items, because customers generally prefer washing clothing items before wearing them, a picture prompt may be sent to a customer a day after it is determined that a clothing item has been delivered to the customer. As another example, for smartphone cases, a picture prompt is sent to a customer immediately upon determining that a smartphone case has been delivered to the customer (or is about to be delivered).

At block 212, at some point after receiving the picture prompt that was sent at block 208, the customer creates a digital media item regarding the custom product, attaches the digital media item to a reply message, and sends the reply message. For example, in an embodiment using smartphones, the customer at customer location 102 receives a text message from merchant computer 110 and decides to follow the prompt; the customer uses camera 106 on the smartphone to capture a digital image of the custom product 10, thus automatically storing a digital image of the actually received custom product in the phone-computing device 104. The customer then forms a reply to the text message, attaching the just-taken digital image either using multipart text messaging or media messaging service (MMS) or providing the digital image as a file attachment. The customer then sends the reply message back to the sending number, associated with merchant computer 110. In a similar example, the picture prompt is sent to a mobile application executing on device 110 and the mobile application allows the use to respond to the picture prompt with a digital image of the received unit.

If the picture prompt sent to the customer is an email message, then the reply message, from the customer, may be an email that includes an attached media item and that also includes data (e.g., order number and/or item number) that merchant computer 110 uses to associate the media item with the product.

If the picture prompt sent to the customer is a message that is sent to the customer's mobile application, then a digital media item that accompanies any reply message from the mobile application can be directly associated with the correct product.

In addition to a digital image, video, or audio, a reply message from a customer may include text (e.g., “The shoes are amazing!”), which may be associated with the product on a product page, along with any digital image.

In some situations, a customer may not reply immediately or ever to a picture prompt. In an embodiment, merchant computer 110 sends, to the customer, a follow-up picture prompt regarding the same unit. The follow-up picture prompt may be sent based on a pre-defined schedule and/or certain events, such as a subsequent order by the customer. The follow-up picture prompt may include one or more incentives to encourage the customer to take a picture. Alternatively, only the first picture prompt sent to a customer for a particular unit includes any incentives in order to encourage the customer to quickly provide information about the delivered unit rather than way for subsequent reminders.

At block 214, the reply message is received with the image file attachment. In an embodiment, the reply message may be inspected and validated. For example, the merchant computer 110 may implement spam prevention logic or other validation logic to ensure that an inbound message is from a known customer. In some embodiments, the sending party's cell phone number may be extracted from a standard SMS header or telephony header and compared to a whitelist of known customer cell phone numbers for validation purposes. The sending party's cell phone number also may be used in a keyed query to the database 114 to determine what action to take next for this customer or party. For example, if a database query on the sending party's cell phone number yields a valid customer record and a prior action value of “1” (or some other specified value), then merchant computer 110 has determined that a valid customer has just replied to an initial prompt message. The database row or record may be updated with a new action value to indicate that the merchant computer 110 has received a digital image from the customer. The action value may be a monotonically incremented integer value to permit recording the receipt of multiple inbound images from the same customer; in some embodiments, the merchant computer 110 may implement a limit on the number of images that the customer may send, for example, after receiving four (4) images (as indicated by an action value of “5” in the customer's database record) the merchant computer could silently drop the current and any subsequent inbound replies.

In an embodiment, different products may be associated with different limits on the number of media items that are to be associated with the products. The limits may pertain to individual customers or may be pertain to all customers. For example, a first product may be associated with a limit of two digital media items from a single customer while a second product may be associated with a limit of five digital media items from a single customer.

At block 216, a correct product database record is determined, with which the inbound digital media item should be associated. For example, the merchant computer 110 obtains the unique order number from the message table, based on looking up the record or row in the message table using information in the reply message, such as the sending party's cell phone number, email address, or item identification data that identifies (or is associated with) the customized product. Based on the order number, the merchant computer 110 retrieves an item identifier for the unit that was delivered to the customer.

In some embodiments, image collection logic 116 and the method of FIG. 2 may be configured to accommodate orders that include multiple products or items. For example, in one embodiment, image collection logic 116 is configured to perform, in response to receiving the signal of block 206, parsing the order details represented in database 114 based on the order or customer identifying information received as part of the signal of block 206, and then generating multiple outbound messages to the customer, in which each message is associated with a different, separate product or line item within a multiple-item/product order. In this embodiment, the customer might receive several messages, for example:
“Enjoying the Hooded Sweatshirt you just received from Zazzle? Share your items with the Zazzle community. Just take a picture of your items, reply to this and attach the picture. We'll add it to the product page so everyone can see what you got.”
“Enjoying the Coffee Table you just received from Zazzle? Share your items with the Zazzle community. Just take a picture of your items, reply to this and attach the picture. We'll add it to the product page so everyone can see what you got.”

A picture prompt may include incentives to further encourage a customer to take a picture of the delivered custom product. For example, a picture prompt may indicate that the customer will receive a 10% off coupon for his/her next purchase at the merchant or next purchase of a product manufactured by manufacturer 140.

In some cases, a customer may order multiple products in a single order. Thus, multiple rows or records in database 114 may indicate that the merchant is awaiting a reply message from the customer, one row or record for each product. If a customer uses a SMS text message, which is essentially stateless, then merchant computer 110 may not know with which product a digital media item (e.g., image, text, video) received from the customer should be associated. This situation may be resolved in one of multiple ways.

In one way, the picture prompt sent to the customer may prompt the customer to enter a certain set of one or more characters for each delivered custom product. For example, for a first custom product, the picture prompt may prompt the customer to enter ‘1’ in the reply message that includes an attached digital image. For a second custom product, the picture prompt may prompt the customer to enter ‘2’ in a reply message that includes an attached digital image of the second custom product.

Another way to associate a digital media item with the correct product is for merchant computer 110 to include product recognition logic that analyzes a digital image received from the customer to determine to which product the digital image belongs. The product recognition logic may limit the analysis to only digital images of items that are part of the order(s) in question. Thus, if the customer ordered three products, three units have been delivered to the customer, and the customer sends a digital image of one of the units to merchant computer 110, then the product recognition logic may compare the received digital image to three digital images, each corresponding to a different one of the three units.

Another way to associate a digital media item with the correct product or item is for the customer to include item identifying information in a digital image of the delivered unit. Examples of item identifying information include a bar code, order number, and item number. The item identifying information may come with the packaging that encloses the delivered unit. For example, such information may be a sticker on the packaging or printed material within the packaging. Merchant computer 110 includes reader logic that is configured to analyze the digital image, identify the item identifying information within the digital image, and determine with which product the item identifying information is associated.

Another way in which a digital media item may be associated with the correct product is merchant computer 110 causing a URL to be included in the picture prompt. When the customer selects the URL, a page may be displayed that allows the customer to upload a media item and select the appropriate product. The page may allow the customer to only select a product that the customer has ordered but for which the customer has not yet provided a digital image (or other media item). In a related embodiment, the URL is uniquely associated with the delivered unit (and no other unit). Thus, when the customer selects the URL, image collection logic 116 “knows” to which product or item an uploaded digital media item should be associated. In this way, the customer does not have to manually select the product to which the digital media item belongs.

Another way in which a digital media item may be associated with the correct product is merchant computer 110 sending picture prompts separately in time and awaiting a reply message for one delivered unit before sending a picture prompt for a second delivered unit. For example, the message table of database 114 may include an item number in addition to the other values identified above, and may include an action value of “0” for successive items in an order for which messages have not yet been sent. Example message table rows for an order of one customer for two items might include:

| Customer Cell Phone | Order Number | Item Number | Action Value |
|---|---|---|---|
| 2135551212 | 0123456 | 001-555999 | 1 |
| 2135551212 | 0123456 | 002-055223 | 0 |

The example message table rows indicate that the process has sent an outbound prompt text message for item number “001-555999”, as indicated by an action value of “1”, but has not sent a picture prompt yet for the second item. This approach enables image collection logic 116 to determine, upon receiving an inbound reply message from a particular customer cell phone number, to which product the attached digital media item pertains by finding the unit in the message table that has an action value that is not “0”. In another embodiment, the merchant's review process for checking the quality and validity of digital images, as further described below, may be used to assign multiple inbound customer digital images to different product records.

At block 218, the customer-provided media item is stored in association with a product database record. For example, a digital image file attachment received in the customer's reply message is stored in the database 114 in association with an item record indicated by the item identifier.

In an embodiment, a digital media item is tagged with a review flag associated with a review workflow at the merchant, which causes a reviewer at the merchant to receive a notification that a new digital image has been received and which prevents the catalog logic 112 from displaying the image in a product page for the associated item. In response, the reviewer checks the newly received image using an offline editor or other image review or manipulation tool, and clears the review flag. A reviewer may also be responsible for associating multiple images with the proper items. Thereafter, the digital media item may be viewed (or otherwise presented) as part of a product page for the unit that the customer ordered. The product page may be for all products of the same type, regardless of customizations. Alternatively, the product page may be only for one or more customized products. In some embodiments, the digital media item may be stored in a specially denoted page or area linked to the product page, titled “Customer Images” or “See What Real Customers Got” or using a similar title.

Optionally, at block 220, an acknowledgment message is sent to the customer. For example, the merchant computer 110 may form and send a message such as “Thanks for helping the Zazzle community! We look forward to serving you again soon. See new products, specials and announcements at www.zazzle.com.” In most smartphones, such a website reference will be interpreted as an active link that is clickable by the receiving user to result in displaying the referenced website, thus providing further engagement with the customer. In an embodiment, block 218 also involves updating the message table record keyed to the customer's cell phone number with an updated action value indicating that an acknowledgment was sent.

In an embodiment, an acknowledgement message includes a coupon code or a link to a coupon code to reward a customer for a digital media item. The coupon code or link may be sent in response to determining that the customer has submitted a certain number of digital media items to the merchant.

Accordingly, a method and computing system has been described that enables a merchant, manufacturer or similar party involved in the trade of selling, making and providing custom-manufactured products with prompt, high-quality, low-friction feedback from customers on manufactured products. The method may take advantage of the convenience of SMS text messaging and the familiarity of text messaging facilities to the typical smartphone user.

Alternatively, e-mail messages may be sent to, for example, personal computers, wearable devices, or tablet computers and users can reply using reply e-mails with digital media items embedded in the reply or provided as file attachments.

### Implementation Example

### Hardware Overview

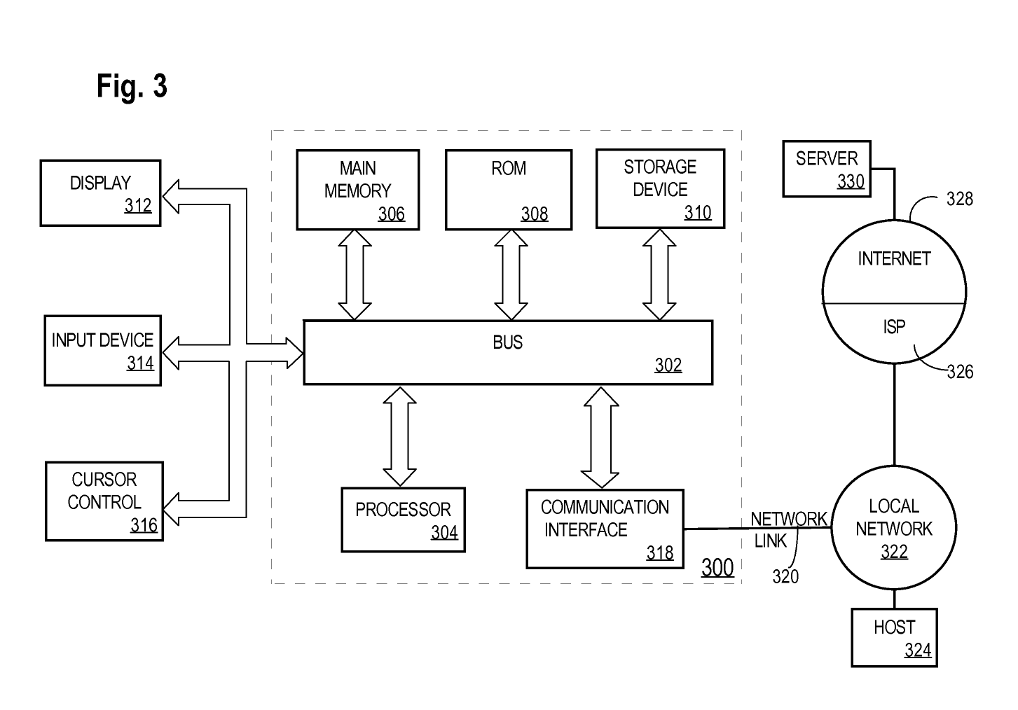

FIG. 3 is a block diagram that illustrates a computer system 300 upon which an embodiment of the invention may be implemented.

Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 300, various machine-readable media are involved, for example, in providing instructions to processor 304 for execution. Such a medium may take many forms, including but not limited to storage media and transmission media. Storage media includes both non-volatile media and volatile media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
receiving, at a merchant, an order by a customer for a custom-manufactured product, the order including a phone number of a computing device that is associated with a camera;
receiving, from a shipper, at the merchant, delivery data that indicates that the shipper has delivered a particular unit of the custom-manufactured product to the customer;
in response to receiving the notification that indicates that the particular unit of the custom-manufactured product has been delivered to the customer, sending, from the merchant, to the computing device, a message that prompts the customer to a reply with a digital image of the particular unit;
receiving, at the merchant, from the computing device, a reply message that includes a digital image, of the particular unit, that has been captured using the camera;
storing, at the merchant, the digital image in association with a product page relating to the custom-manufactured product;
wherein the method is performed using one or more computing devices.

2. The method of claim 1, further comprising:
prior to receiving the reply message, storing data that indicates that the prompt message has been sent to the customer for the particular unit and that a reply message has not yet been received for the particular unit;
in response to receiving the reply message, updating the data to indicate that a reply message has been received for the particular unit.

3. The method of claim 1, wherein the order is for a plurality of products that are to be delivered to the customer, wherein the custom-manufactured product is a first product, the method further comprising:
after sending the prompt message, sending, from the merchant, to the customer, a second prompt message that prompts for a reply with a digital image regarding a second particular unit of a second product that is different than the first product;
receiving, from the customer, at the merchant, a second reply message that includes a second digital image regarding the second particular unit;
storing, at the merchant, the second digital image in association with a second product page relating to the second product.

4. The method of claim 1 wherein the custom-manufactured product was manufactured by a third party maker.

5. A method comprising:
receiving an order for a product that is to be delivered to a customer;
in response to determining that a particular unit of the product has been delivered, sending, to the customer, a prompt message that prompts for a reply with a digital media item regarding the particular unit;
receiving, from the customer, a reply message that includes a digital media item regarding the particular unit;
storing the digital media item in association with a product page relating to the product;
wherein the method is performed using one or more computing devices.

6. The method of claim 5, wherein the steps are performed by a merchant, wherein determining that the particular unit of the product has been delivered comprises receiving, from a shipper that is different than the merchant, confirmation data that indicates that the particular unit has been delivered to a residence of the customer.

7. The method of claim 5, wherein the digital media item is one or more of an image, video, audio, or text.

8. The method of claim 5, wherein:
the order includes a number of a message-capable computing device that is associated with a camera;
the prompt message is sent to the message-capable computing device;
the camera generates the digital media item based on input from the customer;
the reply message is received from the message-capable computing device.

9. The method of claim 8, wherein the prompt message is a first Short Message Service (SMS) text message or a first Multimedia Messaging Service (MMS) message and the reply message is a second MMS message.

10. The method of claim 5, wherein the prompt message is sent to a mobile application that executes on a computing device of the customer and the reply message is generated by the mobile application.

11. The method of claim 5, further comprising:
prior to receiving the reply message, storing data that indicates that the prompt message has been sent to the customer for the particular unit and that a reply message has not yet been received for the particular unit;
in response to receiving the reply message, updating the data to indicate that a reply message has been received for the particular unit.

12. The method of claim 5, wherein the order is for a plurality of products that are to be delivered to the customer, wherein the product is a first product, the method further comprising:
after sending the prompt message, sending, to the customer, a second prompt message that prompts for a reply with a digital media item regarding a second particular unit of a second product that is different than the first product and that is included in the plurality of products;
receiving, from the customer, a second reply message that includes a second digital media item regarding the second particular unit;
storing the second digital media item in association with a second product page relating to the second product.

13. The method of claim 5, wherein the product was manufactured by a third party maker.

14. One or more storage media storing instructions which, when executed by one or more processors, cause:
receiving, at a merchant, an order by a customer for a custom-manufactured product, the order including a phone number of a computing device that is associated with a camera;
receiving, from a shipper, at the merchant, delivery data that indicates that the shipper has delivered a particular unit of the custom-manufactured product to the customer;
in response to receiving the notification that indicates that the particular unit of the custom-manufactured product has been delivered to the customer, sending, from the merchant, to the computing device, a message that prompts the customer to a reply with a digital image of the particular unit;
receiving, at the merchant, from the computing device, a reply message that includes a digital image, of the particular unit, that has been captured using the camera;
storing, at the merchant, the digital image in association with a product page relating to the custom-manufactured product.

15. The one or more storage media of claim 14, wherein the instructions, when executed by the one or more processors, further cause:
prior to receiving the reply message, storing data that indicates that the prompt message has been sent to the customer for the particular unit and that a reply message has not yet been received for the particular unit;
in response to receiving the reply message, updating the data to indicate that a reply message has been received for the particular unit.

16. The one or more storage media of claim 14, wherein the order is for a plurality of products that are to be delivered to the customer, wherein the custom-manufactured product is a first product, wherein the instructions, when executed by the one or more processors, further cause:
after sending the prompt message, sending, from the merchant, to the customer, a second prompt message that prompts for a reply with a digital image regarding a second particular unit of a second product that is different than the first product;
receiving, from the customer, at the merchant, a second reply message that includes a second digital image regarding the second particular unit;
storing, at the merchant, the second digital image in association with a second product page relating to the second product.

17. The one or more storage media of claim 14, wherein the custom-manufactured product was manufactured by a third party maker.

18. One or more storage media storing instructions which, when executed by one or more processors, cause:
receiving an order for a product that is to be delivered to a customer;
in response to determining that a particular unit of the product has been delivered, sending, to the customer, a prompt message that prompts for a reply with a digital media item regarding the particular unit;
receiving, from the customer, a reply message that includes a digital media item regarding the particular unit;
storing the digital media item in association with a product page relating to the product.

19. The one or more storage media of claim 18, wherein sending and storing are performed by a merchant, wherein determining that the particular unit of the product has been delivered comprises receiving, from a shipper that is different than the merchant, confirmation data that indicates that the particular unit has been delivered to a residence of the customer.

20. The one or more storage media of claim 18, wherein the digital media item is one or more of an image, video, audio, or text.

21. The one or more storage media of claim 18, wherein:
the order includes a number of a message-capable computing device that is associated with a camera;
the prompt message is sent to the message-capable computing device;
the camera generates the digital media item based on input from the customer;
the reply message is received from the message-capable computing device.

22. The one or more storage media of claim 21, wherein the prompt message is a first Short Message Service (SMS) text message or a first Multimedia Messaging Service (MMS) message and the reply message is a second MMS message.

23. The one or more storage media of claim 18, wherein the prompt message is sent to a mobile application that executes on a computing device of the customer and the reply message is generated by the mobile application.

24. The one or more storage media of claim 18, wherein the instructions, when executed by the one or more processors, further cause:
prior to receiving the reply message, storing data that indicates that the prompt message has been sent to the customer for the particular unit and that a reply message has not yet been received for the particular unit;
in response to receiving the reply message, updating the data to indicate that a reply message has been received for the particular unit.

25. The one or more storage media of claim 18, wherein the order is for a plurality of products that are to be delivered to the customer, wherein the product is a first product, the method further comprising:
after sending the prompt message, sending, to the customer, a second prompt message that prompts for a reply with a digital media item regarding a second particular unit of a second product that is different than the first product and that is included in the plurality of products;
receiving, from the customer, a second reply message that includes a second digital media item regarding the second particular unit;
storing the second digital media item in association with a second product page relating to the second product.

26. The one or more storage media of claim 18, wherein the product was manufactured by a third party maker.
